(19) United States
(12) Patent Application Publication
(10) Pub. No.: US 2005/0252032 A1
(43) Pub. Date: Nov. 17, 2005

(54) Clothes dryer

(75) Inventors: Young-Hwan Park, Seoul (KR); Si-Moon Jeon, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/028,234

(22) Filed: Jan. 4, 2005

(30) Foreign Application Priority Data
May 11, 2004 (KR) 33175/2004

(51) Int. Cl. F26B 21/06; F26B 11/02

(52) U.S. Cl. 34/604; 34/124

(57) ABSTRACT

A clothes dryer includes: a drum rotatably installed in a cabinet; and an exhaust chamber installed in the cabinet and communicating with the drum for guiding the air from the drum outside the cabinet, the exhaust chamber configured to be detachable into two pieces, thereby reducing a manufacturing cost and improving productivity and efficiency of the operation.

### BACKGROUND OF THE INVENTION

1. Field of the Invention

The present invention relates to a clothes dryer, and particularly, to a clothes dryer having an exhaust chamber configured to be detachable into two pieces.

2. Description of the Background Art

In general, a clothes dryer is installed as another unit from a washing machine, and automatically dries wet clothes that have just been washed. The clothes dryer is divided into a condensing type and an exhausting type according to its drying type.

A condensing clothes dryer dries clothes through the following processes. A heat exchanger is provided in a dryer, and the air is circulated in the dryer. At this time, condensed water from the wet clothes is discharged outside the dryer, but the air undergoes processes of being heated again by a heater and supplied into a drum.

On the other hand, an exhausting clothes dryer dries clothes through the following processes. First, the air sucked from the outside of the dryer is heated by a heater. The heated air is guided into a drum where wet clothes are placed, and the air which becomes moist while passing in the drum is exhausted outside the dryer.

FIG. 1 is a schematic sectional view showing a conventional clothes dryer, and FIG. 2 is a perspective view showing a structure of an exhaust chamber of the conventional clothes dryer.

As shown, the conventional exhausting clothes dryer (hereinafter, shortly referred to as a clothes dryer) includes: a cabinet 10 provided at its front with an opening 10a for putting in an object to be dried; a door 11 for opening or closing the opening 10a of the cabinet 10; a drum 12 rotatably installed in the cabinet 10, for receiving an object to be dried therein; a driving motor 13 mounted at a lower side of the drum 12, for generating a driving force; a driving force transfer means 14 for transferring a driving force of the driving motor 13 to the drum 12; a heater 16 mounted at one side in the cabinet 10, for heating the air guided to the drum 12; and an air flow device for sucking the external air of the cabinet 10, guiding the air to the heater 16, guiding the air heated in the heater 16 to the drum 12, and exhausting the air having passed through the drum 12 outside the cabinet 10 again.

The driving force transfer means 14 comprises: a pulley 14a coupled to one side of a rotary shaft of the driving motor 13; and a belt 14b for transferring a driving force of the driving motor 13 to the drum 12 by winding around a circumferential surface of the drum 12 together with the pulley 14a so as to rotate the drum 12.

The air flow device includes: a suction duct 15a for guiding the air in the cabinet 10 to the drum 12; an exhaust duct 15b for exhausting the air in the drum 12 to the outside; and a blower fan 15c installed toward an inlet of the suction duct in the suction duct 15a, for blowing air by being rotated by the driving motor 13.

As for the suction duct 15a, its inlet is placed at one side of the blower fan 15c and its outlet is installed to communicate with an air suction opening 12a of the drum 12, so that the external air is introduced to the inside through a suction grill 10b and then is guided inside the drum 12.

As for the exhaust duct 15b, its inlet communicates with an air exhaust opening 12b of the drum 12 and its outlet communicates with an exhaust chamber 17.

An exhaust unit 17a integrally and extendingly formed at one side of the exhaust chamber 17 is coupled to and communicates with an exhaust duct (not shown) disposed to the outside of the cabinet 10.

Also, the exhaust units 17a are respectively formed along a direction of both sides of the cabinet 10 and a direction of a rear surface thereof, and are disposed through though holes (not shown) penetratingly formed at the cabinet 10. A user can use the clothes dryer after connecting the exhaust duct (not shown) to an exhaust unit 17a positioned at a portion where disposition of the exhaust duct can be easily made depending on an installation position of the clothes dryer.

In addition, of the exhaust units 17a, exhaust units 17a formed along a direction of both sides of the cabinet 10 are formed to be symmetrical on the basis of an inlet of the exhaust chamber 17 communicating with the exhaust duct 15b, and an exhaust unit 17a which is not used may be blocked by using an opening or closing cap (not shown).

Here, the reference symbol F represents a filter for filtering foreign substances such as waste thread and dregs generated as an object to be dried is dried in the drum 12.

Hereinafter, an operational structure of the above-described clothes drier will now be described.

First, when power is applied to the driving motor 13, the drum 12 is rotated by the belt 14b, mixing objects to be dried in the drum 12. And, the blower fan 15c is also rotated together with the rotation of the drum 12, thereby supplying hot air into the drum 12. In such a manner, the objects to be dried are dried.

To be more specific, the external air is sucked inside the cabinet 10 by rotation of the blower fan 15c. The air sucked in such a manner is heated while passing the heater 16, and is introduced into the drum 12 through the suction duct 15a and the air suction opening 12a. The introduced air dries objects to be dried in the drum 12, and then moves toward the air exhaust opening 12b, drying the objects to be dried again. Then, the air is exhausted to the outside of the cabinet 10 via the air exhaust opening 12b, the exhaust duct 15b, the exhaust chamber 17 and the exhaust duct (not shown).

Meanwhile, the exhaust chamber of the conventional clothes dryer has a complicated structure. For this reason, the exhaust chamber cannot be made by one mold, but should be made by manufacturing two pieces through a separate mold and then integrally coupling the two pieces together by methods such as welding or the like.

However, to integrally couple the two pieces together by a welding method, additional equipment such as special welding jig is required, resulting in an increase in components and the number of processes. For this reason, a cost is also increased and productivity is degraded.

In addition, manufacturing the exhaust chamber using welding method requires a long processing time, and frequently generates defect welding, thereby degrading operation efficiency.

Meanwhile, because the conventional exhaust chamber is not provided with a special means for preventing a drain of condensate water, the condensate water in the exhaust chamber undesirably drains out of the drier through the exhaust pipe.

### SUMMARY OF THE INVENTION

Therefore, an object of the present invention is to provide a clothes drier having an exhaust chamber configured to be detachable into two pieces in order to reduce a cost and improve productivity and efficiency.

Another object of the present invention is to provide a clothes drier capable of preventing a drain of condensate water condensed in an exhaust chamber.

To achieve these and other advantages and in accordance with the purpose of the present invention, as embodied and broadly described herein, there is provided a clothes dryer comprising: a drum rotatably installed in a cabinet; and an exhaust chamber installed in the cabinet and communicating with the drum for guiding the air from the drum outside the cabinet, the exhaust chamber configured to be detachable into two pieces.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a sectional view showing a conventional clothes drier;

FIG. 2 is a perspective view showing a structure of an exhaust chamber of the conventional clothes drier;

FIG. 3 is a perspective view showing an upper portion of an exhaust chamber of a clothes drier in accordance with the present invention;

FIG. 4 is a perspective view of a main part of FIG. 3, which shows a coupling state by a hook;

FIG. 5 is a perspective view showing a lower portion of the exhaust chamber of the clothes drier in accordance with the present invention;

FIG. 6 is an exploded perspective view showing a second assembly of the exhaust chamber in accordance with the present invention;

FIG. 7 is a perspective view showing a main part of FIG. 6;

FIG. 8 is a partial sectional view showing that a first assembly and a second assembly of the exhaust chamber in accordance with the present invention are coupled together by a main hook;

FIG. 9 is a sectional view showing a main part of FIG. 8;

FIG. 10 is a partial sectional view showing that the first assembly and the second assembly of the exhaust chamber in accordance with the present invention are coupled together by an auxiliary hook;

FIG. 11 is a sectional view showing a main part of FIG. 10; and

FIG. 12 is a partially cut-out perspective view showing a means for preventing a drain of condensate water of the exhaust chamber of the clothes drier in accordance with the present invention.

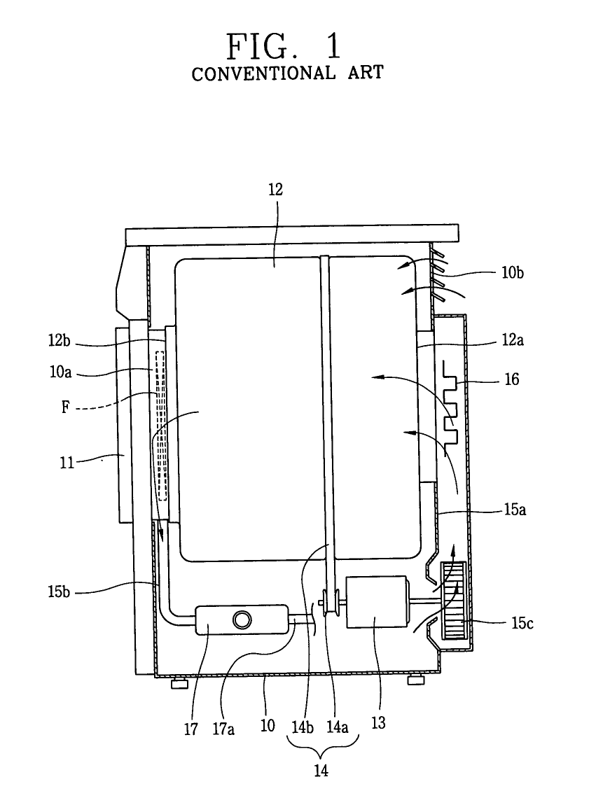

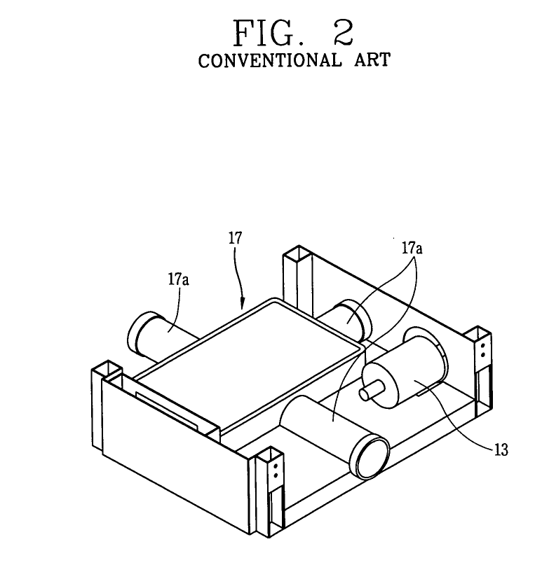

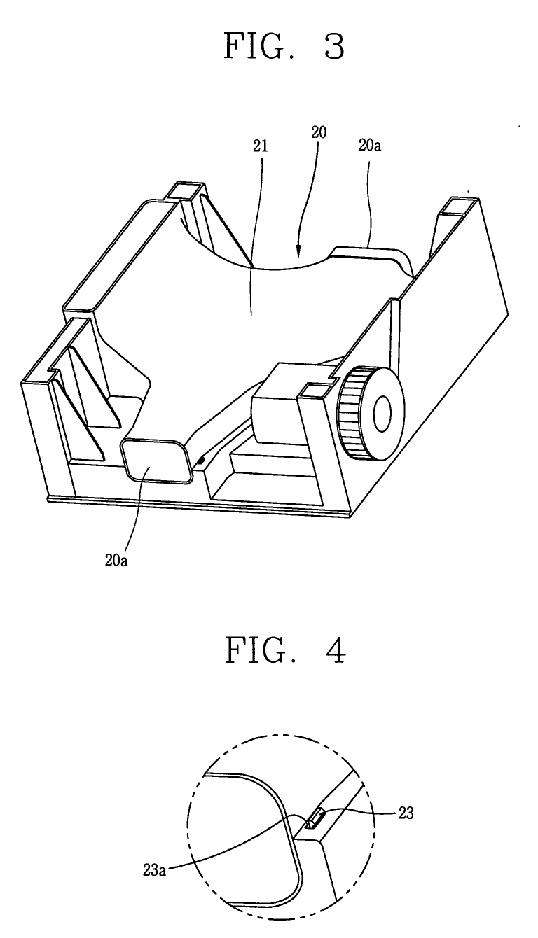

### DETAILED DESCRIPTION OF THE PREFERRED EMBODIMENTS

Reference will now be made in detail to the preferred embodiments of the present invention, examples of which are illustrated in the accompanying drawings.

There may be a plurality of embodiments of a clothes dryer in accordance with the present invention, and the most preferred embodiment will be described.

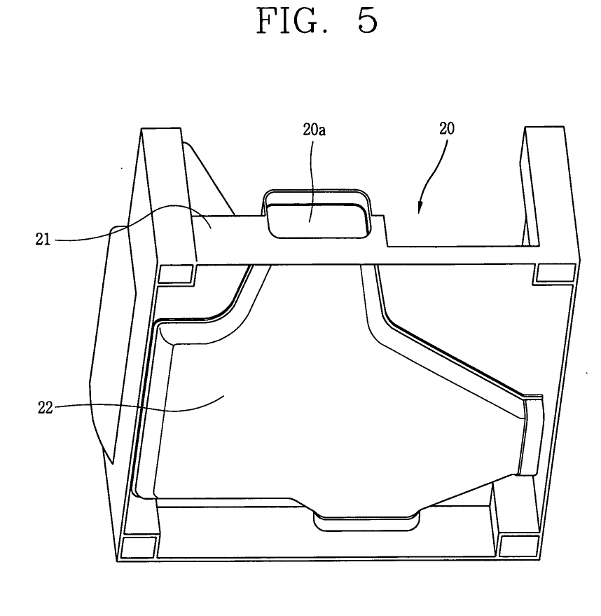

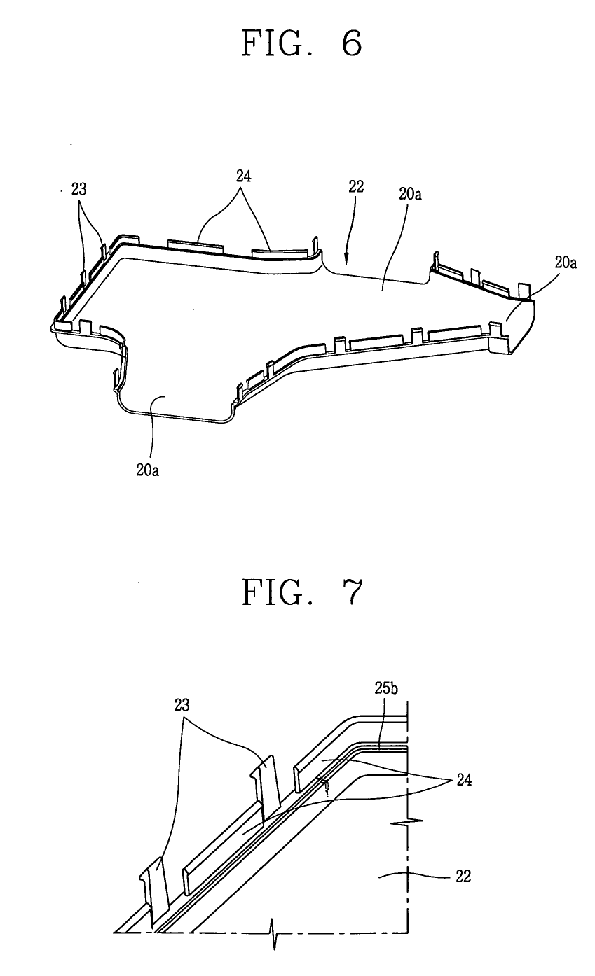

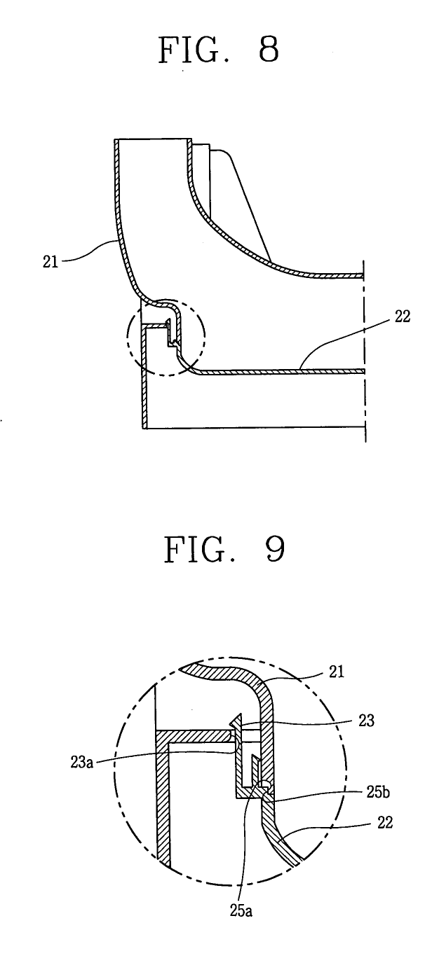

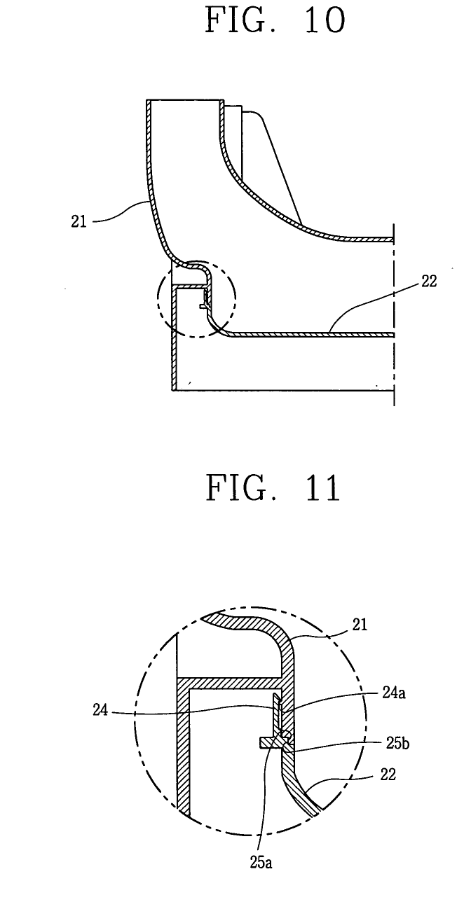

FIG. 5 is a perspective view showing a lower portion of an exhaust chamber of a clothes dryer in accordance with the present invention, FIG. 6 is an exploded perspective view showing a second assembly of an exhaust chamber in accordance with the present invention, and FIG. 7 is a perspective view showing a main part of FIG. 6. FIG. 8 is a partial sectional view showing that a first assembly and a second assembly of the exhaust chamber in accordance with the present invention are coupled together by a main hook, and FIG. 9 is a sectional view showing a main part of FIG. 8. FIG. 10 is a partial sectional view showing that the first assembly and the second assembly of the exhaust chamber in accordance with the present invention are coupled together by an auxiliary hook, and FIG. 11 is a sectional view showing a main part of FIG. 10.

To make the gist of the present invention clear, descriptions on the same construction as the conventional clothes dryer will be omitted, and the same reference numbers are given thereto.

As shown, a clothes dryer in accordance with the present invention includes: a drum 12 rotatably installed in a cabinet; and an exhaust chamber 20 installed in the cabinet 10, communicating with the drum 12 and configured to be detachable into two pieces, for guiding the air from the drum 12 to the outside of the cabinet 10.

The exhaust chamber 20 includes: a first assembly 21 positioned adjacent to the drum 12; a second assembly 22 detachably coupled to the first assembly 21; and a locking unit for coupling the first assembly 21 with the second assembly 22.

The exhaust chamber 20 formed by coupling between the first assembly 21 and the second assembly 22 is provided with a plurality of exhaust openings 20a, so that the air of high temperature and high humidity can be exhausted from the drum to the outside.

The exhaust opening 20a is also formed by coupling between the first assembly 21 and the second assembly 22.

The first assembly 21 and the second assembly 22 constituting the exhaust chamber 20 are coupled to each other by a hooking connection method.

The locking unit includes: a plurality of hooks formed at one of the first and second assemblies 21 and 22 along a surface 25a or 25b where the first assembly 21 and the second assembly 22 are coupled together; and a plurality of hooking portions where the hooks are fixed and which are formed at the rest of the assemblies 21 and 22 along a coupling surface 25a or 25b.

In case that the hooks are formed along the coupling surface 25a of the first assembly 21, the hooking portions where the hooks are fixed are formed along the coupling surface 25b of the second assembly 22. The hook structure may be formed in the opposite manner. As shown in the drawing, a locking unit of the exhaust chamber 20 in accordance with one embodiment of the present invention includes: the plurality of hooks formed at the second assembly 22 along a coupling surface 25b of the second assembly 22; and the plurality of hooking portions formed at the first assembly 21 along a coupling surface 25a of the first assembly 21, corresponding to the plurality of hooks.

The locking unit having such a structure will now be described in more detail.

The locking unit includes: a plurality of main hooks 23 formed at the second assembly 22 along its coupling surface 25b and extending therefrom in a direction that the second assembly 22 is coupled to the first assembly 21; and a plurality of hooking holes 23a penetratingly formed at the first assembly 21 along its coupling surface 25a, so that the main hooks 23 are inserted fixed thereto.

As mentioned above, in contrast, the main hooks 23 may be formed at the first assembly 21, and the plurality of hooking holes 23a matching therewith may be formed at the second assembly 22.

Preferably, the main hooks 23 and the plurality of coupling holes 23a corresponding thereto are formed at regular intervals, but the intervals may be varied depending on a coupling portion.

Also, the locking unit preferably has an additional hooking structure so that the coupling between the first assembly 21 and the second assembly 22 can be made more firmly.

That is, the locking unit has an additional hooking structure. Here, the additional hooking structure includes: auxiliary hooks 24 extendingly formed at one of the first and second assemblies 21 and 22 in a circumferential direction of the coupling surface 25a or 25b; and hooking projections 24a protrudingly formed at the rest of the assemblies 21 and 22 in a circumferential direction of a coupling surface 25a or 25b, so that the auxiliary hooks 24 are hooked thereby.

In one embodiment of the present invention, the auxiliary hooks 24 are formed at the second assembly 22 and the hooking projections 24a are formed at the first assembly 21. However, as mentioned above, the opposite construction is also possible.

The auxiliary hooks 24 and the plurality of hooking projections 24a corresponding thereto are formed at regular intervals, but the intervals may be varied depending on a coupling portion.

Here, the main hooks 23 and the auxiliary hooks 24 are alternately formed. Therefore, preferably, the hooking holes 23a and the hooking projections 24a are also alternately formed to thereby match with the main hooks 23 and the auxiliary hooks 24.

Also, the auxiliary hooks 24 and the hooking projections 24a are may be continuously extendingly formed in a circumferential direction of the coupling surfaces 25a and 25b.

In addition, the main hook 23 and the auxiliary hook 24 are hooked in opposite directions, so that a coupling state between the first assembly 21 and the second assembly 22 can be more stably maintained.

Namely, the locking unit described above can not only maintain the coupling between the first assembly 21 and the second assembly 22 but also selectively separate the two assemblies 21 and 22 from each other.

In order to prevent leakage of condensate water in the exhaust chamber between the coupling surfaces 25a and 25b when the two assemblies 21 and 22 are coupled by such a locking unit, shapes of the coupling surfaces 25a and 25b should be modified.

So, as shown in FIGS. 9 to 11, the coupling surfaces 25a and 25b of the first assembly 21 and the second assembly 22 are preferably stepped to match with each other.

As a matter of course, the coupling surface may be curved in a variety of shapes, thereby expanding a contact area to prevent the leakage of condensate water between the coupling surfaces 25a and 25b.

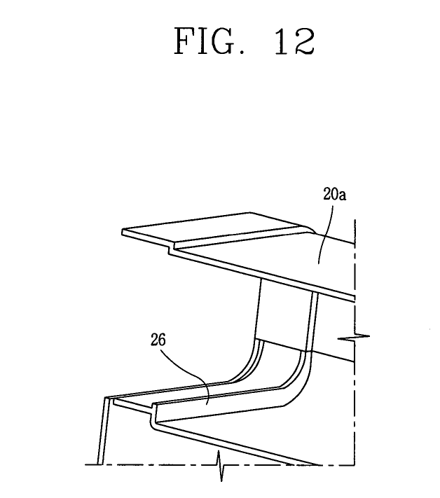

As shown in FIG. 12, a means 26 for preventing a drain of condensate water is provided at an exhaust opening 20a of the exhaust chamber 20 manufactured by coupling between the first assembly 21 and the second assembly 22.

Namely, the means 26 for preventing a drain of condensate water is extendingly formed in a stepped manner from a lower side of an inner circumferential surface of the exhaust opening 20a up to both side walls, so as to prevent a drain of condensate water to the outside through the exhaust opening 20a.

The operation of the clothes dryer in accordance with one embodiment of the present invention described above is the same as that of the conventional clothes dryer. Therefore, detailed descriptions thereon will be omitted.

As so far described, because the clothes dryer in accordance with the present invention employs an exhaust chamber comprised of two pieces, namely, a first assembly and a second assembly which are detachably coupled together by a locking unit using a hooking connection method, the exhaust chamber can be manufactured by coupling the first assembly with the second assembly through a simple coupling process without using a conventional welding process. Accordingly, inconvenience in the operation resulting from the conventional welding process is solved, a manufacturing cost can be reduced, and productivity and efficiency of the operation are improved.

Also, as the exhaust chamber is configured to be detachable, maintenance can be easily carried out.

In addition, a means for preventing a drain of condensate water is formed inside an exhaust opening of the exhaust chamber. When the air of high temperature and high humidity is exhausted from a drum to the outside through the exhaust chamber, part of the air is condensed in the exhaust chamber. At this time, the means for preventing a drain of condensate water can prevent the condensate water from draining outside the clothes dryer.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A clothes dryer comprising:
a drum rotatably installed in a cabinet; and
an exhaust chamber installed in the cabinet and communicating with the drum for guiding the air from the drum outside the cabinet, the exhaust chamber configured to be detachable into two pieces.

2. The clothes dryer of claim 1, wherein the exhaust chamber comprises:
a first assembly positioned adjacent to the drum;
a second assembly detachably coupled to the first assembly; and
a locking unit for coupling the first assembly and the second assembly together.

3. The clothes dryer of claim 2, wherein the locking unit comprises:
a plurality of hooks formed at one of the first and second assemblies along a surface where the first assembly and the second assembly are coupled together; and
a plurality of hooking portions where the hooks are fixed, the hooking portions formed at the rest of the assemblies along its coupling surface.

4. The clothes dryer of claim 3, wherein the locking unit comprises:
a plurality of main hooks extendingly formed at one of the first and second assemblies along its coupling surface in a direction that the first assembly and the second assembly are coupled together; and
a plurality of hooking holes penetratingly formed at the rest of the assemblies along its coupling surface, so that the main hooks are insertedly fixed thereat.

5. The clothes dryer of claim 4, wherein the locking unit further comprises:
auxiliary hooks extendingly formed at one of the first and second assemblies in a circumferential direction of its coupling surface; and
hooking projections protrudingly formed at the rest of the assemblies in a circumferential direction of its coupling surface, so that the auxiliary hook is hooked thereat.

6. The clothes dryer of claim 4, wherein the main hooks and the hooking holes matching therewith are formed at regular intervals.

7. The clothes dryer of claim 5, wherein the auxiliary hooks and the hooking projections matching therewith are formed at regular intervals.

8. The clothes dryer of claim 5, wherein the auxiliary hooks and the hooking projections matching therewith are continuously extendingly formed in a circumferential direction of the coupling surface.

9. The clothes dryer of claim 5, wherein the main hooks and the auxiliary hooks are alternately formed, and accordingly, the hooking holes and the hooking projections are alternately formed so as to match with the main hooks and the auxiliary hooks.

10. The clothes dryer of claim 5, wherein the main hook and the auxiliary hook are hooked in opposite hooking directions.

11. The clothes dryer of claim 3, wherein coupling surfaces of the first assembly and the second assembly are formed in stepped manner to match with each other, so that condensate water in the exhaust chamber does not leak to the outside.

12. The clothes dryer of claim 2, wherein the exhaust chamber is provided with a plurality of exhaust openings communicating with the outside of the cabinet and formed by coupling between the first assembly and the second assembly.

13. The clothes dryer of claim 12, wherein a means for preventing a drain of condensate water is provided in the exhaust opening so as to prevent a drain of condensation water through the exhaust opening.

14. The clothes dryer of claim 13, wherein the means for preventing a drain of condensate water is extendingly formed in a stepped manner from a lower side of an inner circumferential surface of the exhaust opening up to both side walls.
